(19) United States
(12) Patent Application Publication
(10) Pub. No.: US 2010/0292983 A1
(43) Pub. Date: Nov. 18, 2010

(54) MACHINE TRANSLATION APPARATUS AND MACHINE TRANSLATION METHOD

(76) Inventors: Takashi Onishi, Tokyo (JP); Shinichi Ando, Tokyo (JP); Kunihiko Sadamasa, Tokyo (JP)

Correspondence Address: Mr. Jackson Chen, 6535 N. STATE HWY 161, IRVING, TX, 75039, US

(21) Appl. No.: 12/812,133

(22) PCT Filed: Jan. 9, 2009
(86) PCT No.: PCT/JP2009/050195

§ 371 Date: Jul. 8, 2010

(30) Foreign Application Priority Data
Jan. 10, 2008 (JP) 2008-002811

(51) Int. Cl. G06F 17/28

(52) U.S. Cl. 704/2

(57) ABSTRACT

A preprocessing unit (3) identifies an original text input from an input unit (1) as one of a plurality of types of basic element functions defined in advance as basic element functions that construct a description format of a claim, and outputs the original text in basic element functions. A translation unit (4) changes a translation manner in accordance with the type of basic element function of the original text output the preprocessing unit (3). This enables to appropriately translate a claim.

### TECHNICAL FIELD

The present invention relates to a machine translation apparatus and machine translation method and, more particularly, to a machine translation system and machine translation method which appropriately translate a claim in the scope of claims.

### BACKGROUND ART

In machine translation processing, when a long sentence is input, ambiguities in interpretation increase. This leads to increases in the process time, analysis errors, and the like. A typical example is machine translation of a claim which is often constructed by a very long sentence. There has been provided a method for coping with these problems by dividing a claim into appropriate units and individually translating them.

For example, reference 1 (Japanese Patent Laid-Open No. 9-293075) describes an example of a machine translation apparatus which divides an input claim while placing a focus on the style unique to a claim, thereby obtaining an appropriate translation result. As shown in FIG. 7, a machine translation apparatus 201 described in reference 1 includes a pattern collation means 202, pattern storage means 203, layering means 204, hierarchical data reversing means 205, and translation combining means 206.

The machine translation apparatus 201 with the above-described arrangement operates in the following way. First, the pattern collation means 202 executes pattern matching between a claim division pattern stored in the pattern storage means 203 and an input claim, and divides the input claim into phrases such as transitional phrases unique to a claim, indeclinable word phrases, and declinable word phrases. Next, the layering means 204 analyzes each part, and creates a hierarchical structure based on the modification relationship. The hierarchical data reversing means 205 then reverses the hierarchical structure to the word order of Japanese. Finally, the translation combining means 206 translates each layer, and outputs the result.

### DISCLOSURE OF INVENTION

### Problem to be Solved by the Invention

The machine translation apparatus 201 shown in FIG. 7 divides a claim while placing a focus on the style unique to a claim. The apparatus translates the divided units in accordance with the same procedure. For this reason, the apparatus always translates divided units in the same manner irrespective of which one of a plurality of basic element functions of the description format of a claim each divided unit to be translated belongs to.

### Object of Invention

An exemplary object of the invention allows to translate a claim more appropriately than before.

### Means of Solution to the Problem

A machine translation apparatus according to an exemplary aspect of the invention is a machine translation apparatus for converting a claim described in a source language into a target language, including preprocessing means for outputting an original text in basic element functions, the preprocessing means including function identification means for identifying at least part of the input original text as one of a plurality of types of basic element functions defined in advance as basic element functions that construct a description format of a claim, and translation means for changing a translation manner in accordance with the type of basic element function of the original text output from the preprocessing means.

A machine translation method according to another exemplary aspect of the invention is a machine translation method of converting a claim described in a source language into a target language, including the steps of identifying at least part of an input original text as one of a plurality of types of basic element functions defined in advance as basic element functions that construct a description format of a claim, outputting the original text in basic element functions, and performing translation while changing a translation manner in accordance with the output type of basic element function of the original text.

### Effect of the Invention

An exemplary advantage according to the invention is to appropriately translate a claim. This is because the manner of translation by the translation means can be changed for each basic element function of a claim.

### BRIEF DESCRIPTION OF DRAWINGS

FIG. 1 is a block diagram showing an arrangement according to the first exemplary embodiment of the present invention;

FIG. 2 is a flowchart illustrating an operation according to the first exemplary embodiment of the present invention;

FIG. 3 is a block diagram showing an arrangement according to the second exemplary embodiment of the present invention;

FIG. 4 is a flowchart illustrating an operation according to the second exemplary embodiment of the present invention;

FIG. 5 is a block diagram showing an arrangement according to the third exemplary embodiment of the present invention;

FIG. 6 is a flowchart illustrating an operation according to the third exemplary embodiment of the present invention; and

FIG. 7 is a block diagram showing the arrangement of a machine translation apparatus related to the present invention.

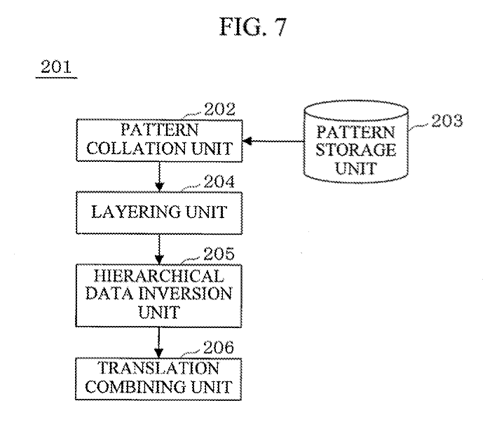

### BEST MODE FOR CARRYING OUT THE INVENTION

### First Exemplary Embodiment

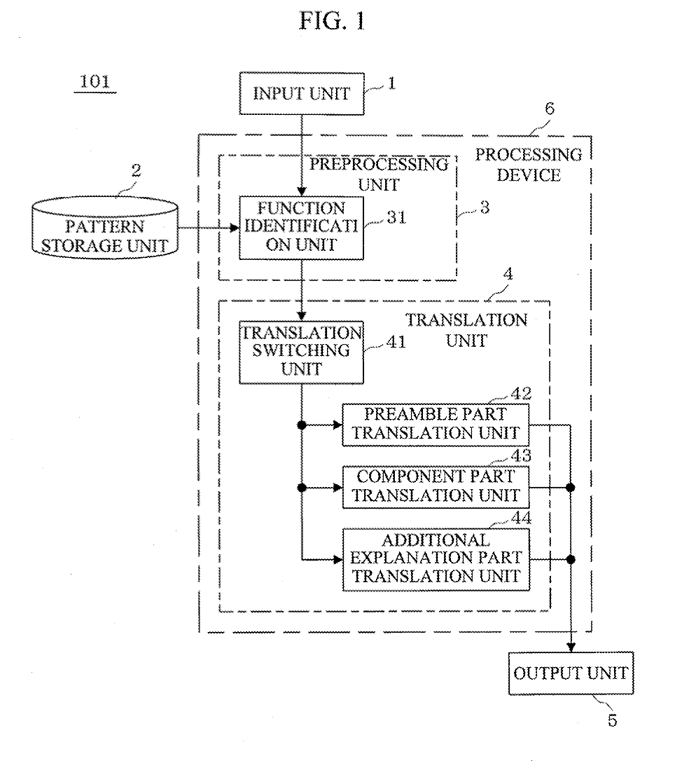

Referring to FIG. 1, a machine translation apparatus 101 according to the first exemplary embodiment of the present invention is a Japanese-English machine translation apparatus which translates a claim described in Japanese and outputs a claim described in English. The machine translation apparatus 101 includes an input unit 1, pattern storage unit 2, output unit 5, and processing device 6 connected to them.

The input unit 1 receives a character string (original text) to be input to the machine translation apparatus 101, and transfers the input character string to a preprocessing unit 3. The input unit 1 is formed from, for example, a keyboard or a file reading device. In this exemplary embodiment, the input unit 1 inputs character strings obtained by dividing a claim described in the source language into basic element functions in advance.

The claim described in the source language includes three types of basic element functions, i.e., preamble part, component part, and additional explanation part. The preamble part describes the preamble of an invention, and corresponds to the preamble and transitional phrase of an English claim. One English claim always includes one preamble. Hence, one Japanese claim described considering international application always includes one preamble. The component part describes a component of the invention. Since an invention usually includes a plurality of components, a plurality of component parts are sometimes described in one claim. The additional explanation part gives an additional explanation to an aforementioned component. The additional explanation part is omitted depending on the claim.

The pattern storage unit 2 stores collation patterns to be used to identify the input character string as one of the preamble part, component part, and additional explanation part defined in advance as the basic element functions that construct the description format of a claim. The pattern storage unit 2 is formed from, for example, a magnetic disk. Each pattern stored in the pattern storage unit 2 is formed from a set of, for example, a pattern condition and an element function to be identified when the pattern condition is satisfied. The pattern condition is a combination of, for example, a variable part and a fixed part. The variable part describes a condition such as an indeclinable word phrase, declinable word phrase, or number, and is coincident with a variable character string. The fixed part directly describes a coincident surface character string.

The claim division pattern used in reference 1 and the collation pattern used in this exemplary embodiment are different in the following point. The claim division pattern used in reference 1 is used to divide a sentence. However, the collation pattern used in this exemplary embodiment is used to identify an element function. In addition, the claim division pattern used in reference 1 is applied to an entire claim. On the other hand, the collation pattern used in this exemplary embodiment is applied to a part of a claim.

The processing device 6 identifies the type of original text of each basic element function input from the input unit 1 using the collation patterns stored in the pattern storage unit 2, translates the original text in accordance with the translation manner corresponding to the identified type of basic element function, and outputs the result from the output unit 5. The processing device 6 includes the preprocessing unit 3 and a translation unit 4.

The preprocessing unit 3 includes a function identification unit 31 which identifies the type of original text of each basic element function input from the input unit 1 as a preamble part, component part, or additional explanation part by performing pattern matching between the input original text and the collation patterns stored in the pattern storage unit 2. The preprocessing unit 3 has a function of transferring the identification result and the input original text to the translation unit 4.

The preprocessing unit 3 may further classify the basic element function identified by the function identification unit 31 into a subordinate group, and transfer the input original text and an identification result including the classification result to the translation unit 4.

For example, the preprocessing unit 3 can identify a basic element function that has been identified as a preamble part as an independent clause preamble part representing the preamble part of an independent clause or a dependent clause preamble part representing the preamble part of a dependent clause. Alternatively, the preprocessing unit 3 can identify a basic element function that has been identified as a component part as an indeclinable component part represented by an indeclinable word or a declinable component part represented by a declinable word.

To identify a preamble part as an independent clause preamble part or a dependent clause preamble part, for example, collation patterns to be used for the identification are stored in the pattern storage unit 2 in advance. The function identification unit 31 can then do identification by pattern matching between the input character string and the collation patterns stored in the pattern storage unit 2.

A component part can be identified as an indeclinable component part or a declinable component part by, for example, determining whether the component is expressed by an indeclinable word phrase or a declinable word phrase.

Note that identifying a preamble part as an independent clause preamble part or a dependent clause preamble part or identifying a component part as an indeclinable component part or a declinable component part is performed after the function identification unit 31 has identified the basic element function. However, the identification may be performed simultaneously with the basic element function identification or before translation processing by a preamble part translation unit 42 or component part translation unit 43 (to be described later) in the translation unit 4.

The translation unit 4 includes a translation switching unit 41, the preamble part translation unit 42, the component part translation unit 43, and an additional explanation part translation unit 44.

The translation switching unit 41 switches the translation unit in accordance with the original text transferred from the preprocessing unit 3 and the type of basic element function added to it and represented by the identification result from the function identification unit 31. More specifically, an original text identified as a preamble part by the function identification unit 31 is transferred to the preamble part translation unit 42 and translated. An original text identified as a component part is transferred to the component part translation unit 43 and translated. An original text identified as an additional explanation part is transferred to the additional explanation part translation unit 44 and translated.

The preamble part translation unit 42 regards an input original text as a preamble part, translates it, and transfers the translation result to the output unit 5. Since the preamble part translation unit 42 translates the input original text while regarding it as a preamble part, the first character of the first word is translated in uppercase. The preamble part translation unit 42 preferably controls translation of the preamble part based on the type of preamble part (whether the preamble part is an independent clause preamble part or a dependent clause preamble part) identified by the function identification unit 31 or the difference in the surface character string. More specifically, the article of the indeclinable word of the subject of the preamble part is controlled based on whether the preamble part is an independent clause preamble part or a dependent clause preamble part. In an independent clause preamble part, the indeclinable word of the subject is translated using an indefinite article because it can be regarded as a firstly mentioned word. In a dependent clause preamble part, the indeclinable word of the subject is translated using a definite article because it can be regarded as an aforementioned word.

The component part translation unit 43 regards an input original text as a component part, translates it, and transfers the translation result to the output unit 5. Since the component part translation unit 43 translates the input original text while regarding it as a component part, the first character of the first word is not capitalized. The component part translation unit 43 preferably controls translation of the component part based on the type of component part (whether the component part is an indeclinable component part or a declinable component part) identified by the function identification unit 31 or the surface character string. More specifically, when a component part is identified as an indeclinable component part, the component part translation unit 43 controls the article depending on whether the indeclinable word is located at the position of the subject. An indeclinable word located at the position of the subject is translated using an indefinite article because it can be regarded as a firstly mentioned word. An indeclinable word located not at the position of the subject is translated using a definite article because it can be regarded as an aforementioned word.

The additional explanation part translation unit 44 regards an input original text as an additional explanation part, translates it, and transfers the translation result to the output unit 5. Since the additional explanation part translation unit 44 translates the input original text while regarding it as an additional explanation part, the first character of the first word is not capitalized.

The translation unit 4 according to this exemplary embodiment incorporates the translation switching unit 41, preamble part translation unit 42, component part translation unit 43, and additional explanation part translation unit 44, and causes the translation switching unit 41 to switch the translation unit. However, the translation unit 4 may be designed to control translation processing in one internal translation unit by giving a type of basic element function to the single translation unit as a parameter.

The preprocessing unit 3 and translation unit 4 having the above-described arrangements can be implemented by programs and a computer that constructs the processing device 6. The programs are stored in a computer-readable recording medium such as a magnetic disk or a semiconductor memory. Upon booting the computer, the programs are read out by the computer. The operation of the computer is controlled so as to cause it to function as the preprocessing unit 3 or the translation unit 4.

The output unit 5 is formed from a display device or printer for outputting the obtained translation result.

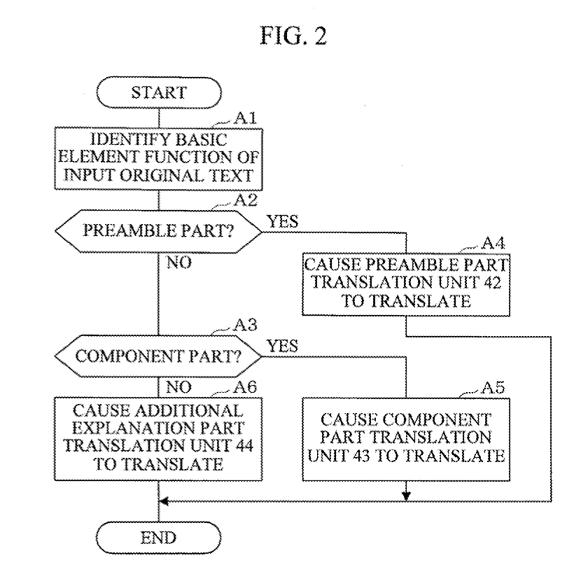

The overall operation according to this exemplary embodiment will be described next with reference to FIG. 1 and the flowchart of FIG. 2.

First, the preprocessing unit 3 causes the function identification unit 31 to identify the type of basic element function of the character string input from the input unit 1, and transfers the identification result and the input character string to the translation unit 4 (step A1 of FIG. 2). In the translation unit 4, the translation switching unit 41 determines whether the identification result indicates a preamble part (step A2). Upon determining in step A2 that the identification result indicates a preamble part, the preamble part translation unit 42 translates the input character string (step A4). Upon determining in step A2 that the identification result does not indicate a preamble part, the translation switching unit 41 determines whether the identification result indicates a component part (step A3). Upon determining in step A3 that the identification result indicates a component part, the component part translation unit 43 translates the input character string (step A5). Upon determining in step A3 that the identification result does not indicate a component part, the identification result is determined to indicate an additional explanation part, and the additional explanation part translation unit 44 translates the input character string (step A6).

The effects of this exemplary embodiment will be described next.

In this exemplary embodiment, the original text input from the input unit 1 is identified as one of a preamble part, component part, and additional explanation part, which construct the description format of a claim, and the manner of translation is controlled in accordance with the identification result. This allows to appropriately translate a claim. More specifically, it is possible to capitalize the first character of the first word for a preamble part but inhibit capitalization of the first character of the first word for a component part or an additional explanation part.

Additionally, a preamble part is further classified into an independent clause preamble part or a dependent clause preamble part, and the manner of translation is controlled in accordance with the classification. This enables to more appropriately translate a claim. More specifically, if an expression [symbol] [Japanese language]” is identified as an independent clause preamble part, it can be translated into “◯◯, comprising:”. If the expression is identified as a dependent clause preamble part, it can be translated into “◯◯, wherein”.

Articles need to be strictly distinguished in translating a claim. It is possible to appropriately distinguish articles in translation in accordance with the identified element functions.

### Example of First Exemplary Embodiment

Example 1 based on the first exemplary embodiment will be described next. Example 1 assumes that the machine translation apparatus is a Japanese-English machine translation apparatus for translating a Japanese claim into English.

In Example 1, the input unit 1 inputs, to the processing device 6, a claim divided into basic element functions in advance. For example, a claim description [symbol] [symbol] [symbol] [symbol] [symbol] [symbol] [symbol] [symbol] [symbol] [symbol] [symbol] [Japanese language]” is divided as [symbol] [symbol] [symbol] [symbol] [symbol] [symbol] [symbol] [symbol] [symbol] [symbol] [symbol] [symbol] [Japanese language]” and input. “/” indicates a division point.

Before a description of the processing procedure, the collation patterns stored in the pattern storage'unit 2 will be explained.

In this example, the pattern storage unit 2 stores collation patterns shown in Table 1 and collation patterns shown in Table 2. The collation patterns in Table 1 are used to identify a basic element function as one of a preamble part, component part, and additional explanation part. Each collation pattern is formed from a set of a pattern condition and a type of basic element function to be identified as a result. A parenthesized notation in the table indicates a variable part of a pattern condition. A condition to be satisfied by a variable part is described in parentheses. The remaining parts are the fixed parts of the pattern conditions. For example, the collation pattern of the first line indicates that an input character string which satisfies a pattern condition “(indeclinable word phrase) [symbol] [Japanese language]”, is identified as a preamble part. The collation pattern group shown in Table 1 includes no collation pattern which yields an identification result indicating an additional explanation part. An input character string that has satisfied no collation patterns is identified as an additional explanation part.

TABLE 1

| Pattern condition for basic | Identification |
|---|---|
| element function identification | result |
| (indeclinable word phrase) [symbol] | preamble part |
| [symbol] [Japanese language] | |
| [symbol] (number) [symbol] (indeclinable | preamble part |
| word phrase) [symbol] [Japanese language] | |
| (indeclinable word phrase) [symbol] | component part |
| [Japenese language] | |
| (indeclinable word phrase) [symbol] | component part |
| [symbol] [Japanese language] | |
| (indeclinable word phrase) [symbol] | component part |
| [symbol] [Japanese language] | |
| (declinable word phrase (without | component part |
| subject)) [symbol] [Japanese | |
| language] | |

The collation patterns in Table 2 are used to further identify a basic element function that has been identified as a preamble part as an independent clause preamble part or a dependent clause preamble part. Each collation pattern is formed from a set of a pattern condition and a type of preamble part to be identified as a result. A parenthesized notation in the table indicates a variable part of a pattern condition. A condition to be satisfied by a variable part is described in parentheses. The remaining parts are the fixed parts of the pattern conditions. For example, the collation pattern of the first line indicates that if an input character string which constitutes a preamble part includes a part satisfying a pattern condition [symbol] (number) [symbol] [Japanese language]”, the preamble part is identified as a dependent clause preamble part. The collation pattern group shown in Table 2 includes no collation pattern which yields an identification result indicating an independent clause preamble part. A preamble part that has satisfied no collation patterns is identified as an independent clause preamble part.

TABLE 2

| Pattern condition for preamble | Identification |
|---|---|
| part type identification | result |
| [symbol] (number) [symbol] [Japanese | dependent clause |
| language] | preamble part |
| [symbol] (number 1) [symbol] (number 2) [symbol] | dependent clause |
| [symbol] [symbol] [Japanese language] | preamble part |

The processing procedure will be described in detail using the above-described examples.

First, [symbol] [symbol] [Japanese language]”, [symbol] [symbol] [symbol] [symbol] [Japanese language]”, or the like is input to the input unit 1.

Next, the preprocessing unit 3 performs pattern matching between the input character string and the pattern condition of each collation pattern in Table 1, thereby identifying the character string as one of the basic element functions. The example [symbol] [symbol] [Japanese language]” satisfies the pattern condition “(indeclinable word phrase) [symbol] [Japanese language]” of the collation pattern of the first line of Table 1. Hence, the character string is identified as a preamble part. A character string identified as a preamble part is further identified as an independent clause preamble part or a dependent clause preamble part by determining whether it satisfies the pattern condition of a collation pattern in Table 2. More specifically, if the preamble part satisfies one of the pattern conditions in Table 2, it is identified as a dependent clause preamble part. If the preamble part satisfies none of the pattern conditions, it is identified as an independent clause preamble part. The example [symbol] [symbol] [Japanese language]” satisfies none of the pattern conditions in Table 2. Hence, the preamble part is identified as an independent clause preamble part.

The example [symbol] [symbol] [symbol] [Japanese language]” satisfies the pattern condition “(indeclinable word phrase) [symbol] [Japanese language]” of the collation pattern of the fourth line of Table 1. Hence, the character string is identified as a component part. A character string identified as a component part is further identified as an indeclinable component part or a declinable component part by determining whether the variable part is an indeclinable word phrase or a declinable word phrase. In the example [symbol] [symbol] [symbol] [Japanese language]”, [symbol] [symbol] [Japanese language]” is an indeclinable word phrase. Hence, the component part is identified as an indeclinable component part.

The example [symbol] [symbol] [symbol] [Japanese language]” satisfies none of the pattern conditions in Table 1. Hence, the character string is identified as an additional explanation part.

The translation switching unit 41 switches the translation unit in accordance with the basic element function identified by the preprocessing unit 3. In the example [symbol] [symbol] [Japanese language]”, the identification result indicates a preamble part. Hence, the translation unit is switched to the preamble part translation unit 42. In the example [symbol] [symbol] [symbol] [Japanese language]”, the identification result indicates a component part. Hence, the translation unit is switched to the component part translation unit 43. In the example [symbol] [symbol] [symbol] [Japanese language]”, the identification result indicates an additional explanation part. Hence, the translation unit is switched to the additional explanation part translation unit 44.

The translation processing of the preamble part translation unit 42, component part translation unit 43, and additional explanation part translation unit 44 will be described below.

The translation processing of the preamble part translation unit 42 will be described first. The preamble part is divided into a citation part, body part, and fixed form part, and translated. The citation part corresponds to a pattern condition in Table 2 such as [symbol] (number) [symbol] [Japanese language]” which describes the dependence relationship between claims. The body part describes the invention itself using an indeclinable word phrase. The fixed form part is a transitional phrase having a fixed form such as [symbol] [Japanese language]” or [symbol] [Japanese language]” at the end. As for the example [symbol] [symbol] [Japanese language]”, since this claim is an independent clause, there is no citation part. The body part is [symbol] [symbol] [Japanese language]”, and the fixed form part is [symbol] [Japanese language]”.

Translation of the preamble part is done in accordance with a dedicated rule for each of the body part, citation part, and fixed form part. To translate Japanese into English, the translation result of the body part, that of the citation part, and that of the fixed form part are sequentially combined to obtain the translation result of the preamble part. Since the preamble part is located at the head of the text in an English claim, the first character of the first word is translated in uppercase.

When translating the body part, since it is known to be an indeclinable word phrase, machine translation is performed to translate an indeclinable word phrase. The article of the indeclinable word of the subject of the body part is controlled in accordance with the type of preamble part, i.e., an independent clause preamble part or a dependent clause preamble part. For example, in an independent clause preamble part, the indeclinable word is translated using an indefinite article because it can be regarded as a firstly mentioned word. In a dependent clause preamble part, the indeclinable word is translated using a definite article because it can be regarded as an aforementioned word.

Translation of the citation part is determined by pattern matching with a predetermined condition. Table 3 shows pattern conditions for citation part translation and detailed translation examples. For example, in the translation pattern of the first line, a part that satisfies the pattern condition [symbol] (number) [symbol] [Japanese language]” is translated into “according to claim (num)”.

TABLE 3

| Pattern condition for citation | Translation of |
|---|---|
| part translation | citation part |
| [symbol] (number) [symbol] [Japanese | according to claim |
| language] | (num) |
| [symbol] (number) [symbol] (number 2) [symbol] | according to any one |
| [symbol] [symbol] [Japanese | of claims (num 1) to |
| language] | (num 2) |

Translation of the fixed form part is determined by the combination of the type of preamble part (whether the preamble part is an independent clause preamble part or a dependent clause preamble part) and the words of the fixed form part. Table 4 shows conditions for fixed form part translation and detailed translation examples. For example, in the translation pattern of the first line, when the type of preamble part is an independent clause preamble part, and the fixed form part is [symbol] [Japanese language]”, it is translated into “, comprising:”. The fixed form part [symbol] [symbol] [Japanese language]” in a dependent clause preamble part is translated into “, wherein” by applying the translation pattern of the third line.

TABLE 4

| | Fixed form part | Translation of |
|---|---|---|
| Element function | PGP- 122, ART | fixed form part |
| independent | [symbol] | , comprising: |
| clause preamble | [Japanese language] | |
| part | | |
| independent | [symbol] | , comprising: |
| clause preamble | [Japanese language] | |
| part | | |
| dependent clause | [symbol] | , wherein |
| preamble part | [Japanese language] | |
| dependent clause | [symbol] | , wherein |
| preamble part | [Japanese language] | |
| dependent clause | [symbol] | , further |
| preamble part | [Japanese language] | comprising: |
| dependent clause | [symbol] | , further |
| preamble part | [Japanese language] | comprising: |

According to the above-described translation processing, [symbol] [symbol] [Japanese language]” is translated in the following way. First, the translation result of the body part [symbol] [Japanese language]” is “A machine translation apparatus”. The translation result of the fixed form part [symbol] [Japanese language]” is “, comprising:”. These translation results are combined to obtain “A machine translation apparatus, comprising:”. [symbol] [symbol] [symbol] [Japanese language]” is a dependent clause preamble part because it includes [symbol] [Japanese language]”. In this example, the translation result of the body part is “The machine translation apparatus”, that of the citation part is “according to claim 1”, and that of the fixed form part is “, wherein”. These translation results are combined to obtain “The machine translation apparatus according to claim 1, wherein”.

The translation processing of the component part translation unit 43 will be described next. The component part is divided into a body part and a fixed form part, and translated. The body part describes a component of the invention using an indeclinable word phrase or a declinable word phrase. The fixed form part describes the relationship between components by, e.g., [symbol] [Japanese language]” or [symbol] [symbol] [Japanese language]” at the end. As for the example [symbol] [symbol] [Japanese language]”, the body part is [symbol] [Japanese language]”, the body part is [symbol] [Japanese language]”.

Translation of the component part is done in accordance with a dedicated rule for each of the body part and the fixed form part. The translation result of the body part and that of the fixed form part are sequentially combined to obtain the translation result of the component part. Since the component part follows the preamble part, the first character of the first word is not capitalized.

Translation of the body part is controlled based on the type of component part, the condition of a surface character string, and the presence/absence of a subject. As for control of an article in the body part, when the indeclinable word of the body part is located at the position of the subject, it can be regarded as a firstly mentioned word, and is therefore translated using an indefinite article. However, if the body part ends with [symbol] [Japanese language]” (translated into means), it is translated without using an article. When the indeclinable word of the body part is located not at the position of the subject, it can be regarded as an aforementioned word, and is therefore translated using a definite article. Table 5 shows conditions for body part translation and examples of translation manner designation determined by the conditions. According to the example of Table 5, for example, when the body part is [symbol] [symbol] [symbol] [Japanese language]”, this component part is an indeclinable component part. Since the body part ends with “ [symbol] [Japanese language]”, the translation pattern of the first line of Table 5 is applied. More specifically, the translation manner designation is “** means for gerund phrase” without an article. That is, the component part is translated into “translation means for translating Japanese into English”.

TABLE 5

| | | Designation of |
|---|---|---|
| Element | Condition of body | translation manner |
| function | part | of body part |
| indeclinable | end with “ [symbol] | translate into “** |
| component part | [Japanese language]” | means for gerund |
| | | phrase” (without article) |
| indeclinable | end with “ [symbol] | translate into “** |
| component part | [Japanese language]” | step of gerund phrase” |
| | or [symbol] [symbol] [ | (indefinite article) |
| | Japanese language]” | |
| indeclinable | end with another word | translate as in |
| component part | | general machine |
| | | translation |
| | | (indefinite article) |
| declinable | subject is absent | translate into |
| component part | | gerund phrase |

Translation of the fixed form part is determined by pattern matching with a predetermined condition. Table 6 shows pattern conditions for fixed form part translation and detailed translation examples. For example, the translation pattern of the second line of Table 6 indicates that a fixed form part [symbol] [Japanese language]” is translated into “; and”. According to this translation pattern, [symbol] [Japanese language]” is translated in the following way. The body part [symbol] [Japanese language]” is translated into “an input apparatus”. The fixed form part [symbol] [Japanese language]” is translated into “;”. These translation results are combined to obtain “an input apparatus;”.

TABLE 6

| | Translation of fixed form |
|---|---|
| Fixed form part | part |
| [symbol] [Japanese language] | ; |
| [symbol] [Japanese language] | ; and |
| [symbol] [symbol] | • |
| [Japanese language] | |
| [symbol] [Japanese language] | , wherein |
| , [Japanese language] | ; |
| [symbol] | |
| [Japanese language] | • |

Finally, the translation processing of the additional explanation part translation unit 44 will be described. Translation of the additional explanation part is performed basically in the same way as in general machine translation. Since the additional explanation part is located at the end of a claim, the first character of the first word is not capitalized.

According to the above-described translation processing, the example [symbol] [symbol] [symbol] [Japanese language]” is translated into “said translation means uses pattern translation.”.

Translation processing of a claim progresses in the above-described way. As for the example [symbol] [symbol] [symbol] [symbol] [symbol] [symbol] [symbol] [symbol] [symbol] [symbol] [Japanese language]”, translation processing is individually executed as [symbol] [symbol] [Japanese language]” →“A machine translation apparatus, comprising:” [symbol] [Japanese language]” →“an input apparatus;” [symbol] [symbol] [symbol] [Japanese language]” →“translation means for translating Japanese into English; and” [symbol] [Japanese language]” →“an output apparatus, wherein” [symbol] [symbol] [symbol] [Japanese language]” →“said translation means uses pattern translation.” so that the claim is appropriately translated.

The effects of Example 1 will be described next.

The convention machine translation apparatus cannot control translation in accordance with element functions. For example, both [symbol] [symbol] [Japanese language]” of an independent clause and [symbol] [symbol] [symbol] [Japanese language]” of a dependent clause are translated using “comprising:”. On the other hand, the machine translation apparatus 101 of this example can control translation in accordance with basic element functions. Hence, a dependent clause is translated using “wherein” so that an appropriate translation result can be obtained.

The conventional machine translation apparatus needs to translate one whole claim at once to grasp the structure of the entire claim. The machine translation apparatus 101 of this example can translate each basic element function. The user can translate the basic element functions in any order. This is because identification of a basic element function can be done independently of other basic element functions. This produces an effect of appropriately capitalizing the first character or translating an article even when retranslating only a specific basic element function.

Describing the target language itself in a pattern condition enables to cope with even an input mixed with the target language by the same framework. For example, the conventional machine translation system cannot correctly analyze an input [symbol] [Japanese language], comprising:”. However, when “, comprising:” is registered as a fixed form part of a preamble part, the character string can be translated in accordance with the same procedure as that for [symbol] [symbol] [Japanese language]”, and a translation result “A machine translation apparatus, comprising:” can be obtained.

### Second Exemplary Embodiment

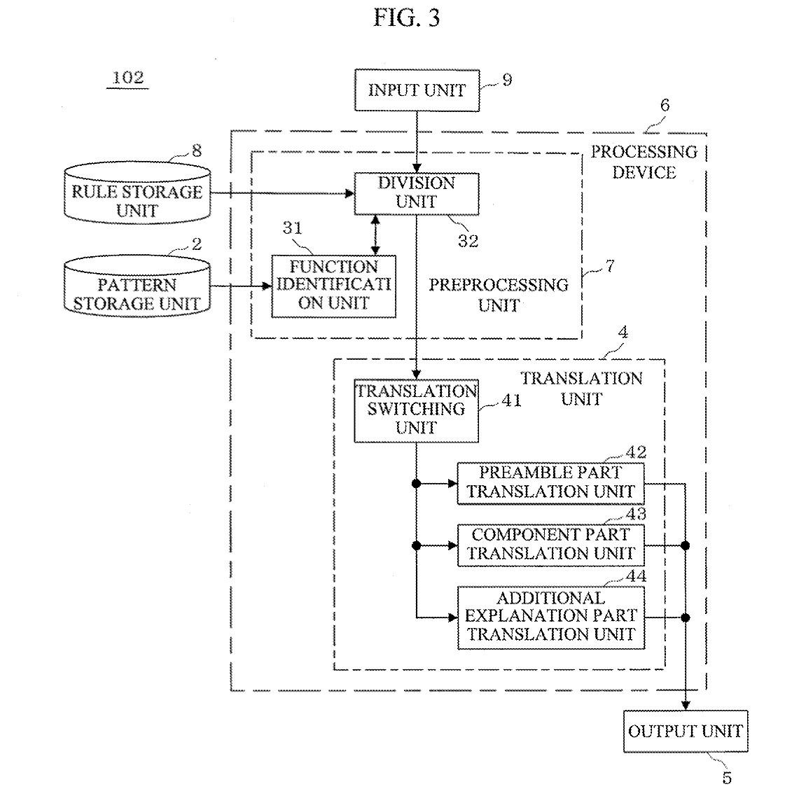

Referring to FIG. 3, a machine translation apparatus 102 according to the second exemplary embodiment of the present invention is different from the machine translation apparatus 101 of the first exemplary embodiment shown in FIG. 1 in that an input unit 9 and a preprocessing unit 7 replace the input unit 1 and the preprocessing unit 3, and the apparatus further includes a rule storage unit 8. The remaining points are the same as in the machine translation apparatus 101 according to the first exemplary embodiment. The input unit 9 inputs the entire original text of one claim to be translated, unlike the input unit 1 of the first exemplary embodiment which inputs the original text of each basic element function of a claim.

The preprocessing unit 7 includes a division unit 32 in addition to a function identification unit 31, unlike the preprocessing unit 3 of the first exemplary embodiment.

The division unit 32 has a function of dividing the input original text into basic element functions using the function identification unit 31.

The rule storage unit 8 stores the restriction rule of the order relationship of the basic element functions. A claim includes three types of basic element functions, i.e., preamble part, component part, and additional explanation part. The order relationship of the basic element functions is restricted. The rule storage unit 8 stores a rule concerning the restriction in advance, and the division unit 32 refers to them.

More specifically, the division unit 32 extracts a part, i.e., a basic element function that satisfies a pattern condition for basic element function identification from the input claim using the function identification unit 31, and divides the claim by the sequence of basic element functions complying with the restriction rule of the order relationship stored in the rule storage unit 8. In case of existence of a plurality of possible divisions, a component may be added to present a plurality of candidates to the user via an output unit 5, and cause the user to input a selection via the input unit 9 and thus select a correct division. Alternatively, in case of a failure in satisfying a pattern condition, a component may be added to allow the user to edit the expression of the claim.

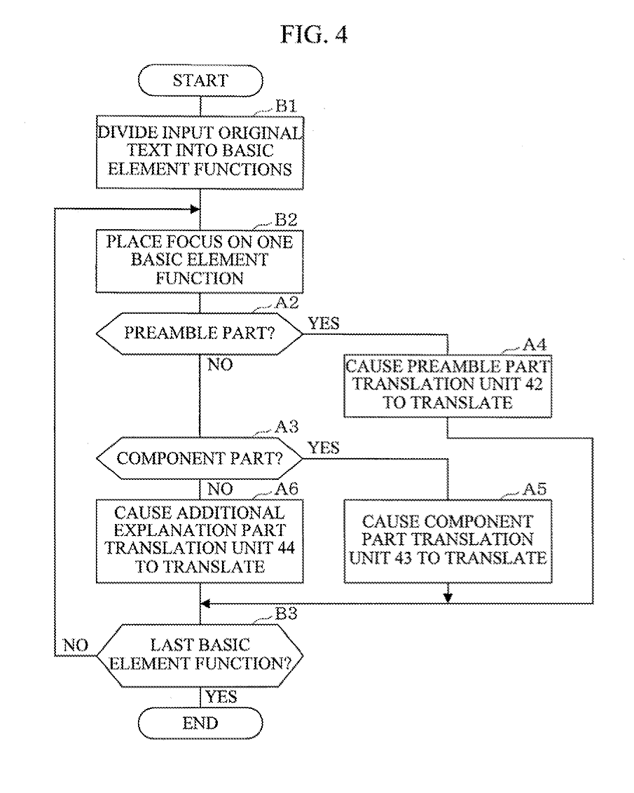

The overall operation according to this exemplary embodiment will be described next with reference to FIG. 3 and the flowchart of FIG. 4.

First, the preprocessing unit 7 divides the original text of an entire claim input from the input unit 9 into basic element functions (step B1 of FIG. 4). In correspondence with each basic element function obtained by division, a character string that forms the basic element function and the type of basic element function are held in a memory (not shown). There are three types of basic element functions, i.e., preamble part, component part, and additional explanation part. The function identification unit 31 identifies the type of preamble part as an independent clause preamble part or a dependent clause preamble part, and adds the identification result to the preamble part. The function identification unit 31 also identifies the type of component part as an indeclinable component part or a declinable component part, and adds the identification result to the component part.

Next, the preprocessing unit 7 places a focus on a process target, for example, one basic element function at the top out of the basic element functions obtained by division (step B2). The original text of the basic element function of interest undergoes translation processing in accordance with the same procedure as in the first exemplary embodiment (step A2 to A6). When translation of one basic element function has ended, the preprocessing unit 7 shifts the focus on one of the remaining basic element functions, and the same processing is repeated. This processing is repeated for all basic element functions obtained by division (step B3).

The effect of this exemplary embodiment will be described next.

In this exemplary embodiment, the preprocessing unit 7 automatically divides an input claim into the basic element functions. This obviates the need for the operation of dividing the claim into the basic element functions in advance before input when translating the entire claim, and allows to increase the efficiency of translation operation.

### Example of Second Exemplary Embodiment

Example 2 based on the second exemplary embodiment will be described next. Example 2 also assumes that the machine translation apparatus is a Japanese-English machine translation apparatus which translates a Japanese claim [symbol] [symbol] [symbol] [symbol] [symbol] [symbol] [symbol] [symbol] [symbol] [symbol] [symbol] [Japanese language]” into English.

First, the input unit 9 inputs the entire text [symbol] [symbol] [symbol] [symbol] [symbol] [symbol] [symbol] [symbol] [symbol] [symbol] [Japanese language]”.

The division unit 32 of the preprocessing unit 7 divides the input claim into basic element functions. The division unit 32 performs the division in accordance with, for example, the following restriction rule stored in the rule storage unit 8.

(preamble part)(component part)+(additional explanation part)?

In this restriction rule, + represents one or more repetitions, and ? represents omissibility. That is, the above restriction rule represents that one preamble part exists first, one or more component parts then follow, and the text ends with a component part or one additional explanation part.

For the example of the input claim [symbol] [symbol] [symbol] [symbol] [symbol] [symbol] [symbol] [symbol] [symbol] [symbol] [Japanese language]”, the function identification unit 31 performs matching with the pattern conditions in Table, thereby identifying [symbol] [symbol] [Japanese language]” as a preamble part, [symbol] [Japanese language]”, [symbol] [symbol] [symbol] [Japanese language]”, and [symbol] [Japanese language]” as component parts, and [symbol] [symbol] [symbol] [Japanese language]” as an additional explanation part. The sequence of the basic element functions satisfies the above-described restriction rule. Hence, the division unit 32 determines that the input claim can be divided as [symbol] [symbol] [symbol] [symbol] [symbol] [symbol] [symbol] [symbol] [symbol] [symbol] [Japanese language]”.

However, other than the above division example, if the function identification unit 31 analyzes [symbol] [symbol] [symbol] [symbol] [Japanese language]” as one noun phrase, and consequently analyzes the whole text [symbol] [symbol] [symbol] [symbol] [Japanese language]” as one component part, a division candidate [symbol] [symbol] [symbol] [symbol] [symbol] [symbol] [symbol] [symbol] [symbol] [symbol] [symbol] [Japanese language]” also exists. If there are a plurality of division candidates, the division unit 32 presents the plurality of candidates to the user via the output unit 5, and causes the user to input a selection instruction of a correct division via the input unit 9.

Assume that the division unit 32 divides the text as [symbol] [symbol] [symbol] [symbol] [symbol] [symbol] [symbol] [symbol] [symbol] [Japanese language]”. Then, the same translation processing as in the first exemplary embodiment is performed for each basic element function so that an appropriate translation result is obtained as

A machine translation apparatus, comprising:

an input apparatus;

translation means for translating Japanese into English; and

an output apparatus, wherein

said translation means uses pattern translation.

The effect of Example 2 will be described next. In the first exemplary embodiment, it is necessary to divide a claim into basic element functions in advance before input. In the second exemplary embodiment, however, since the division is done automatically using the pattern conditions for basic element function identification, or the apparatus assists manual input, the division operation is easily.

### Third Exemplary Embodiment

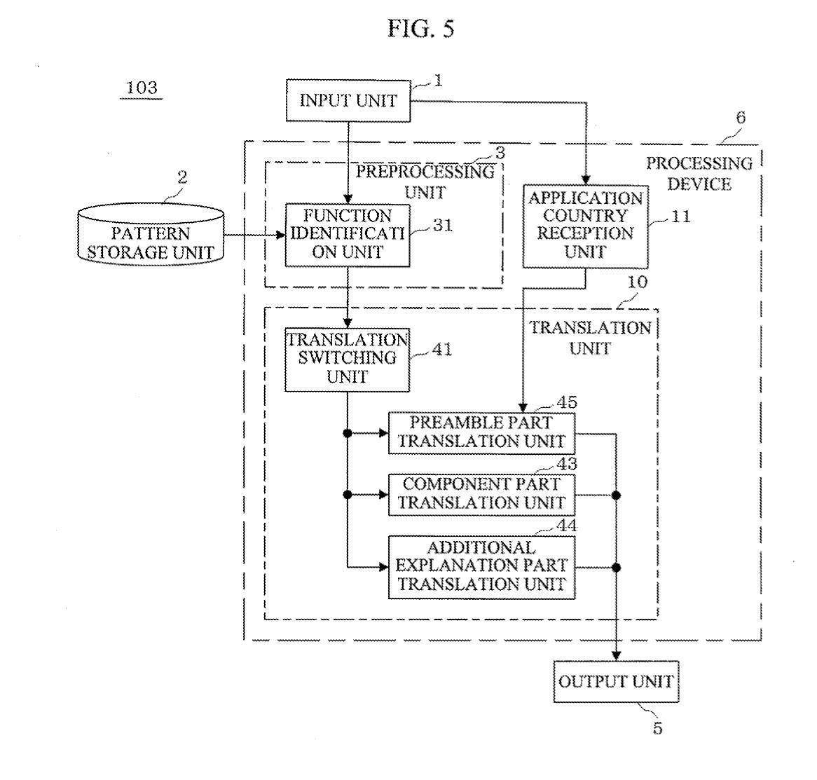

Referring to FIG. 5, a machine translation apparatus 103 according to the third exemplary embodiment of the present invention is different from the machine translation apparatus 101 of the first exemplary embodiment shown in FIG. 1 in that a translation unit 10 replaces the translation unit 4, and the apparatus further includes an application country reception unit 11. The remaining points are the same as in the machine translation apparatus 101 according to the first exemplary embodiment.

The application country reception unit 11 receives, from the user via an input unit 1, a designation of a country or region (to be referred to as an application country hereinafter) where application documents including translated claims are to be filed, and transfers the designation to the translation unit 10. The application country reception unit 11 can also be implemented by programs and a computer that constructs a processing device 6, like the preprocessing unit 7 and the translation unit 10.

The translation unit 10 is different from the translation unit 4 of the first exemplary embodiment in that a preamble part translation unit 45 replaces the preamble part translation unit 42.

The preamble part translation unit 45 has a function of controlling the manner of translation of a preamble part in accordance with the application country received by the application country reception unit 11, unlike the preamble part translation unit 42 of the first exemplary embodiment.

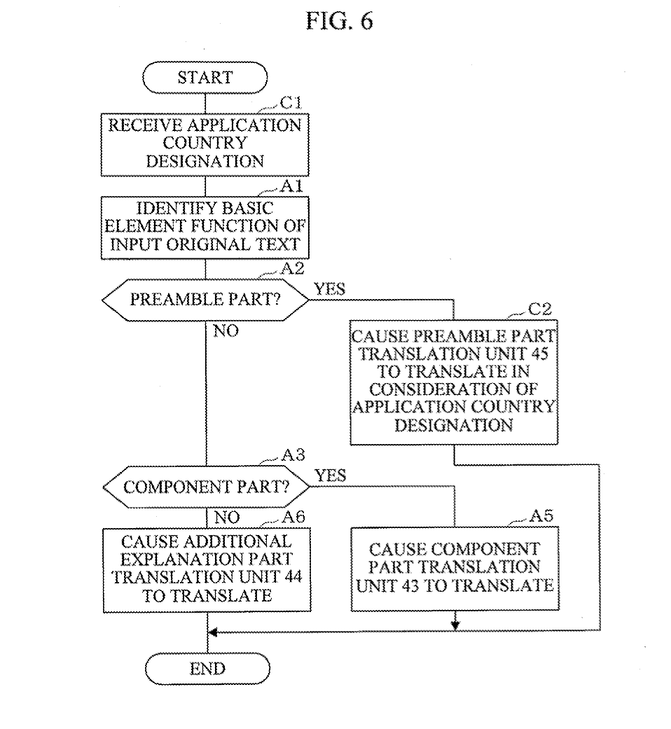

The overall operation according to this exemplary embodiment will be described next with reference to FIG. 5 and the flowchart of FIG. 6.

First, the application country reception unit 11 receives a designation of an application country (step C1 of FIG. 6). The translation unit is switched (steps A1, A2, and A3), and each translation unit performs translation (steps C2, A5, and A6) in accordance with the same procedure as in the first exemplary embodiment. If the input original text is a preamble part, and the preamble part translation unit 45 is to translate the input original text, the preamble part translation unit 45 controls the translation in accordance with the application country received by the application country reception unit 11 (step C2).

The effect of this exemplary embodiment will be described next.

In this exemplary embodiment, translation in a style according to a designated application country is possible.

### Example of Third Exemplary Embodiment

Example 3 based on the third exemplary embodiment will be described next. Example 3 also assumes that the machine translation apparatus is a Japanese-English machine translation apparatus for translating a Japanese claim into English.

The arrangement of Example 3 is the same as that of Example 1. However, unlike Example 1, the application country reception unit 11 receives a designation of one of U.S.A. and Europe as an application country. In addition, fixed form part translation by the preamble part translation unit 45 is controlled in consideration of the distinction between U.S.A. and Europe in a condition, which is received by the application country reception unit 11, in addition to the distinction between an independent clause preamble part and a dependent clause preamble part and the words of the fixed form part.

Table 7 shows conditions for fixed form part translation by the preamble part translation unit 45 and detailed translation examples. For example, in the translation pattern of the first line, when the type of preamble part is an independent clause preamble part, the application country is U.S.A., and the fixed form part is [symbol] [symbol] [Japanese language]”, it is translated into “, comprising:”. When the application country is Europe, the same fixed form part [symbol] [Japanese language]” in the same independent clause preamble part is translated into “, characterized by comprising:”.

TABLE 7

| Element | Application | Fixed form | Translation of |
|---|---|---|---|
| function | country | part | fixed form part |
| independent | U.S.A. | [symbol] | , comprising: |
| clause | | [Japanese | |
| preamble part | | language] | |
| independent | Europe | [symbol] | , characterized |
| clause | | [Japanese | by comprising: |
| preamble part | | language] | |
| dependent | U.S.A. | [symbol] | , wherein |
| clause | | [Japanese | |
| preamble part | | language] | |
| dependent | Europe | [symbol] | , characterized |
| clause | | [Japanese | in that |
| preamble part | | language] | |
| dependent | U.S.A. | [symbol] | , further |
| clause | | [symbol] | comprising: |
| preamble part | | [Japanese | |
| | | language] | |
| dependent | Europe | [symbol] | , characterized |
| clause | | [symbol] | by further |
| preamble part | | [Japanese | comprising: |
| | | language] | |

According to this translation pattern, if the application country is designated as Europe, and the input is [symbol] [symbol] [Japanese language]”, it is identified as a preamble part and, more particularly, as an independent clause preamble part. The translation result is “A machine translation apparatus, characterized by comprising:”.

The effect of Example 3 will be described. In the first exemplary embodiment, the translation unit cannot be controlled depending on the application country. However, the arrangement of the third exemplary embodiment, can receive an application country designation from the outside and control the translation unit in accordance with the application country. It is therefore possible to appropriately perform translation in accordance with the application country.

In the above-described third exemplary embodiment and Example 3, translation of a preamble part is controlled in accordance with an application country designation. However, it is also possible to control translation of a component part by a component part translation unit 43 and translation of an additional explanation part by an additional explanation part translation unit 44 in accordance with an application country designation. The application country reception unit 11 may be added to the second exemplary embodiment and Example 2 so as to control translation by the translation unit 4 in accordance with an application country.

The present invention has been described above with reference to the exemplary embodiments and examples. However, the present invention is not limited to the above-described exemplary embodiments and examples. The arrangement and details of the invention can be variously modified within the scope of the invention, and these modifications will readily occur to those skilled in the art. For example, the exemplary embodiments and examples have exemplified Japanese-English translation. However, translation of another language such as English-Japanese translation can also be done in the same way.

### INDUSTRIAL APPLICABILITY

The present invention is applicable to a machine translation apparatus for translating a claim.

This application is based upon and claims the benefit of priority from Japanese patent application No. 2008-002811, filed on Jan. 10, 2008, the disclosure of which is incorporated herein in its entirety by reference.

1-48. (canceled)

49. A machine translation apparatus for converting a claim described in a source language into a target language, comprising:
a preprocessing unit that outputs an original text in basic element function(s), said preprocessing unit comprising a function identification unit that identifies at least part of the input original text as one of a plurality of types of basic element functions defined in advance as basic element functions that construct a description format of a claim and are to be translated in the same way; and
a translation unit that changes a translation manner in accordance with the type of basic element function of the original text output from said preprocessing unit.

50. A machine translation apparatus according to claim 49, wherein said preprocessing unit further comprising a division unit that divides the input original text into the basic element functions using said function identification unit.

51. A machine translation apparatus according to claim 49, wherein the basic element functions include at least one of a basic element function constructing a preamble part which is a part describing a preamble of an invention, a basic element function constructing a component part which is a part describing a component of the invention, and a basic element function constructing an additional explanation part which is a part giving an additional explanation to an aforementioned component.

52. A machine translation apparatus according to claim 51, wherein said translation unit capitalizes a first character of a first word when an identification result of said function identification unit indicates the preamble part, and otherwise, inhibits capitalization of the first character of the first word.

53. A machine translation apparatus according to claim 51, wherein the basic element function constructing the preamble part is classified as one of an independent clause preamble part that is a preamble part of an independent clause and a dependent clause preamble part that is a preamble part of a dependent clause.

54. A machine translation apparatus according to claim 53, wherein when an identification result of said function identification unit indicates the preamble part, said translation unit controls translation of the preamble part depending on whether the preamble part is the independent clause preamble part or the dependent clause preamble part.

55. A machine translation apparatus according to claim 54, wherein when the identification result of said function identification unit indicates the independent clause preamble part, said translation unit translates an indeclinable word of a subject using an indefinite article, and when the identification result of said function identification unit indicates the dependent clause preamble part, said translation unit translates the indeclinable word of the subject using a definite article.

56. A machine translation apparatus according to claim 51, wherein the basic element function constructing the component part is classified as one of an indeclinable component part having an indeclinable word phrase as a subject and a declinable component part having a declinable word phrase as a subject.

57. A machine translation apparatus according to claim 56, wherein when an identification result of said function identification unit indicates the component part, said translation unit controls translation of the component part depending on whether the component part is the indeclinable component part or the declinable component part.

58. A machine translation apparatus according to claim 57, wherein when the identification result of said function identification unit indicates the indeclinable component part, said translation unit controls translation of the component part depending on whether an indeclinable word representing a component located at a position of a subject ends with a specific character string.

59. A machine translation apparatus according to claim 58, wherein the specific character string includes at least one of [symbol] [Japanese language]”, [symbol] [Japanese language]”, and [symbol] [Japanese language]”.

60. A machine translation apparatus according to claim 57, wherein when the identification result of said function identification unit indicates the indeclinable component part, said translation unit translates the indeclinable word representing the component located at the position of the subject using an indefinite article.

61. A machine translation apparatus according to claim 57, wherein when the identification result of said function identification unit indicates the indeclinable component part, said translation unit translates the indeclinable word representing the component located at the position of the subject using an indefinite article, and translates remaining indeclinable words using definite articles.

62. A machine translation apparatus according to claim 49, wherein said function identification unit identifies the type of basic element function using pattern matching based on a pattern including a variable part that designates a condition by a part of speech and a fixed part that designates a surface character string.

63. A machine translation apparatus according to claim 49, further comprising an application country reception unit that receives an application country,
wherein said translation unit changes the translation manner in accordance with the application country received by said application country reception unit.

64. A machine translation apparatus according to claim 63, wherein said application country reception unit selectively receives one of U.S.A. and Europe as the application country.

65. A machine translation method of converting a claim described in a source language into a target language, comprising the steps of:
identifying at least part of an input original text as one of a plurality of types of basic element functions defined in advance as basic element functions that construct a description format of a claim and are to be translated in the same way;
outputting the original text in basic element function(s), and
performing translation while changing a translation manner in accordance with the output type of basic element function of the original text.

66. A machine translation method according to claim 65, further comprising the step of dividing the input original text into the basic element functions.

67. A machine translation method according to claim 65, wherein the basic element functions include at least one of a basic element function constructing a preamble part which is a part describing a preamble of an invention, a basic element function constructing a component part which is a part describing a component of the invention, and a basic element function constructing an additional explanation part which is a part giving an additional explanation to an aforementioned component.

68. A machine translation method according to claim 67, wherein the step of performing translation comprises the step of capitalizing a first character of a first word when an identification result indicates the preamble part, and otherwise, inhibiting capitalization of the first character of the first word.

69. A machine translation method according to claim 67, wherein the basic element function constructing the preamble part is classified as one of an independent clause preamble part that is a preamble part of an independent clause and a dependent clause preamble part that is a preamble part of a dependent clause.

70. A machine translation method according to claim 69, wherein the step of performing translation comprises the step of controlling translation of the preamble part depending on whether an identification result indicates the independent clause preamble part or the dependent clause preamble part.

71. A machine translation method according to claim 70, wherein the step of controlling comprises the steps of:
when the identification result indicates the independent clause preamble part, translating an indeclinable word of a subject using an indefinite article; and
when the identification result indicates the dependent clause preamble part, translating the indeclinable word of the subject using a definite article.

72. A machine translation method according to claim 67, wherein the basic element function constructing the component part is classified as one of an indeclinable component part having an indeclinable word phrase as a subject and a declinable component part having a declinable word phrase as a subject.

73. A machine translation method according to claim 72, wherein the step of performing translation comprises the step of controlling translation of the component part depending on whether an identification result indicates the indeclinable component part or the declinable component part.

74. A machine translation method according to claim 73, wherein the step of controlling comprises the step of, when the identification result indicates the indeclinable component part, controlling translation of the component part depending on whether an indeclinable word representing a component located at a position of a subject ends with a specific character string.

75. A machine translation method according to claim 74, wherein the specific character string includes at least one of [symbol] [Japanese language]”, [symbol] [Japanese language]”, and [symbol] [Japanese language]”.

76. A machine translation method according to claim 73, wherein the step of controlling comprises the step of, when the identification result indicates the indeclinable component part, translating the indeclinable word representing the component located at the position of the subject using an indefinite article.

77. A machine translation method according to claim 73, wherein the step of controlling comprises the step of, when the identification result indicates the indeclinable component part, translating the indeclinable word representing the component located at the position of the subject using an indefinite article, and translating remaining indeclinable words using definite articles.

78. A machine translation method according to claim 65, wherein the step of identifying comprises the step of identifying the type of basic element function using pattern matching based on a pattern including a variable part that designates a condition by a part of speech and a fixed part that designates a surface character string.

79. A machine translation method according to claim 65, further comprising the step of receiving an application country,
wherein the step of performing translation comprises the step of changing the translation manner in accordance with the received application country.

80. A machine translation method according to claim 79, wherein the step of receiving comprises the step of selectively receiving one of U.S.A. and Europe as the application country.

81. A computer-readable storage medium storing a machine translation program which causes a computer constituting a machine translation apparatus for converting a claim described in a source language into a target language to function as:
a preprocessing unit that outputs an original text in basic element function(s), said preprocessing unit comprising a function identification unit that identifies at least part of the input original text as one of a plurality of types of basic element functions defined in advance as basic element functions that construct a description format of a claim and are to be translated in the same way; and
a translation unit that changes a translation manner in accordance with the type of basic element function of the original text output from said preprocessing unit.

82. A computer-readable storage medium storing a machine translation program according to claim 81, wherein said preprocessing unit further comprising a division unit that divides the input original text into the basic element functions using said function identification unit.

83. A computer-readable storage medium storing a machine translation program according to claim 81, wherein the basic element functions include at least one of a basic element function constructing a preamble part which is a part describing a preamble of an invention, a basic element function constructing a component part which is a part describing a component of the invention, and a basic element function constructing an additional explanation part which is a part giving an additional explanation to an aforementioned component.

84. A computer-readable storage medium storing a machine translation program according to claim 83, wherein said translation unit capitalizes a first character of a first word when an identification result of said function identification unit indicates the preamble part, and otherwise, inhibits capitalization of the first character of the first word.

85. A computer-readable storage medium storing a machine translation program according to claim 83, wherein the basic element function constructing the preamble part is classified as one of an independent clause preamble part that is a preamble part of an independent clause and a dependent clause preamble part that is a preamble part of a dependent clause.

86. A computer-readable storage medium storing a machine translation program according to claim 85, wherein when an identification result of said function identification unit indicates the preamble part, said translation unit controls translation of the preamble part depending on whether the preamble part is the independent clause preamble part or the dependent clause preamble part.

87. A computer-readable storage medium storing a machine translation program according to claim 86, wherein when the identification result of said function identification unit indicates the independent clause preamble part, said translation unit translates an indeclinable word of a subject using an indefinite article, and when the identification result of said function identification unit indicates the dependent clause preamble part, said translation unit translates the indeclinable word of the subject using a definite article.

88. A computer-readable storage medium storing a machine translation program according to claim 83, wherein the basic element function constructing the component part is classified as one of an indeclinable component part having an indeclinable word phrase as a subject and a declinable component part having a declinable word phrase as a subject.

89. A computer-readable storage medium storing a machine translation program according to claim 88, wherein when an identification result of said function identification unit indicates the component part, said translation unit controls translation of the component part depending on whether the component part is the indeclinable component part or the declinable component part.

90. A computer-readable storage medium storing a machine translation program according to claim 89, wherein when the identification result of said function identification unit indicates the indeclinable component part, said translation unit controls translation of the component part depending on whether an indeclinable word representing a component located at a position of a subject ends with a specific character string.

91. A computer-readable storage medium storing a machine translation program according to claim 90, wherein the specific character string includes at least one of [symbol] [Japanese language]”, [symbol] [Japanese language]”, and [symbol] [Japanese language]”.

92. A computer-readable storage medium storing a machine translation program according to claim 89, wherein when the identification result of said function identification unit indicates the indeclinable component part, said translation unit translates the indeclinable word representing the component located at the position of the subject using an indefinite article.

93. A computer-readable storage medium storing a machine translation program according to claim 89, wherein when the identification result of said function identification unit indicates the indeclinable component part, said translation unit translates the indeclinable word representing the component located at the position of the subject using an indefinite article, and translates remaining indeclinable words using definite articles.

94. A computer-readable storage medium storing a machine translation program according to claim 81, wherein said function identification unit identifies the type of basic element function using pattern matching based on a pattern including a variable part that designates a condition by a part of speech and a fixed part that designates a surface character string.

95. A computer-readable storage medium storing a machine translation program according to claim 81, further causing the computer to function as an application country reception unit that receives an application country,
wherein said translation unit changes the translation manner in accordance with the application country received by said application country reception unit.

96. A computer-readable storage medium storing a machine translation program according to claim 95, wherein said application country reception unit selectively receives one of U.S.A. and Europe as the application country.

97. A machine translation apparatus for converting a claim described in a source language into a target language, comprising:
preprocessing means for outputting an original text in basic element function(s), said preprocessing means comprising function identification means for identifying at least part of the input original text as one of a plurality of types of basic element functions defined in advance as basic element functions that construct a description format of a claim and are to be translated in the same way; and
translation means for changing a translation manner in accordance with the type of basic element function of the original text output from said preprocessing means.
